(19) United States
(12) Patent Application Publication
(10) Pub. No.: US 2013/0185461 A1
(43) Pub. Date: Jul. 18, 2013

(54) DEVICE MANAGEMENT APPARATUS, DEVICE MANAGEMENT SYSTEM, AND COMPUTER PROGRAM PRODUCT

(71) Applicants: Yoshihiro Narita, Kanagawa (JP); Atsushi Ishigaki, Tokyo (JP)

(72) Inventors: Yoshihiro Narita, Kanagawa (JP); Atsushi Ishigaki, Tokyo (JP)

(21) Appl. No.: 13/742,724

(22) Filed: Jan. 16, 2013

(30) Foreign Application Priority Data
Jan. 18, 2012 (JP) 2012-008437
Dec. 7, 2012 (JP) 2012-268729

(51) Int. Cl. G06F 11/30

(52) U.S. Cl. CPC G06F 11/3051
USPC 710/15

(57) ABSTRACT

A device management apparatus manages a device. The device management apparatus includes a contract information acquiring unit that acquires contract information on quality assurance of the device; a state information acquiring unit that acquires state information indicating a state of the device; a determining unit that determines whether the state of the device satisfies a content of a contract based on the contract information and the state information; and a notifying unit that notifies a determination result.

### CROSS-REFERENCE TO RELATED APPLICATIONS

The present application claims priority to and incorporates by reference the entire contents of Japanese Patent Application No. 2012-008437 filed in Japan on Jan. 18, 2012 and Japanese Patent Application No. 2012-268729 filed in Japan on Dec. 7, 2012.

### BACKGROUND OF THE INVENTION

1. Field of the Invention

The present invention relates to a device management apparatus, a device management system, and a computer program product.

2. Description of the Related Art

Conventionally, there is a known technology that monitors a state of a device via a network to detect maintenance needed for the device, and urges an administrator to perform the maintenance (for example, see Japanese Patent Application Laid-open No. 2002-55850).

In recent years, in some cases, a contract of quality assurance is made with a customer to assure the quality of a maintenance service of the device. However, if a contract violated state is continued, the service level may be reduced.

Therefore, there is a need for a device management apparatus a device management system capable of preventing a reduction in a service level.

### SUMMARY OF THE INVENTION

According to an embodiment, there is provided a device management apparatus manages a device. The device management apparatus includes a contract information acquiring unit that acquires contract information on quality assurance of the device; a state information acquiring unit that acquires state information indicating a state of the device; a determining unit that determines whether the state of the device satisfies a content of a contract based on the contract information and the state information; and a notifying unit that notifies a determination result.

According to another embodiment, there is provided a device management system that manages a device. The device management system includes a contract information storage unit that stores therein contract information on quality assurance of the device; a contract information acquiring unit that acquires the contract information from the contract information storage unit; a state information acquiring unit that acquires state information indicating a state of the device; a determining unit that determines whether the state of the device satisfies a content of a contract based on the contract information and the state information; and a notifying unit that notifies a determination result.

According to still another embodiment, there is provided a device management system that manages a device. The device management system includes a device management apparatus that manages the device; a contract information storage device that stores therein contract information on quality assurance of the device; a contract information acquiring unit that acquires the contract information from the contract information storage device; a state information acquiring unit that acquires state information indicating a state of the device; a determining unit that determines whether the state of the device satisfies a content of a contract based on the contract information and the state information; and a notifying unit that notifies a determination result.

According to still another embodiment, there is provided a computer program product that includes a non-transitory computer-readable medium having computer-readable program codes embodied in the medium for a computer to manage a device. The program codes, when executed, cause the computer to execute acquiring contract information on quality assurance of the device; acquiring state information indicating a state of the device; determining whether the state of the device satisfies a content of a contract based on the contract information and the state information; and notifying a determination result.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration example of a device management system according to a first embodiment;

FIG. 2 is a block diagram illustrating a configuration example of a device management apparatus according to the first embodiment;

FIG. 3 is a diagram illustrating an example of SLA information according to the first embodiment;

FIG. 4 is a diagram illustrating an example of device information according to the first embodiment;

FIG. 5 is a flowchart illustrating an exemplary process performed by the device management apparatus according to the first embodiment;

FIG. 6 is a block diagram illustrating a configuration example of a device management apparatus according to a second embodiment;

FIG. 7 is a diagram illustrating an example of SLA information according to the second embodiment;

FIG. 8 is a diagram illustrating an example of the power consumption of a device per day according to the second embodiment;

FIG. 9 is a flowchart illustrating an exemplary process performed by the device management apparatus according to the second embodiment;

FIG. 10 is a block diagram illustrating a configuration example of a device management system according to a third embodiment;

FIG. 11 is a block diagram illustrating a configuration example of a device management apparatus according to the third embodiment;

FIG. 12 is a flowchart illustrating an exemplary process performed by the device management apparatus according to the third embodiment;

FIG. 13 is a diagram illustrating an example of SLA information according to a modification;

FIG. 14 is a block diagram illustrating a configuration example of a device management system according to another modification;

FIG. 15 is a block diagram illustrating a configuration example of a device management apparatus according to the modification; and

FIG. 16 is a block diagram illustrating an example of a hardware configuration of the device management apparatus according to the embodiments and the modifications.

### DETAILED DESCRIPTION OF THE PREFERRED EMBODIMENTS

Exemplary embodiments of the present invention will be explained below with reference to the accompanying drawings.

### First Embodiment

A configuration of a device management apparatus according to a first embodiment will be explained below.

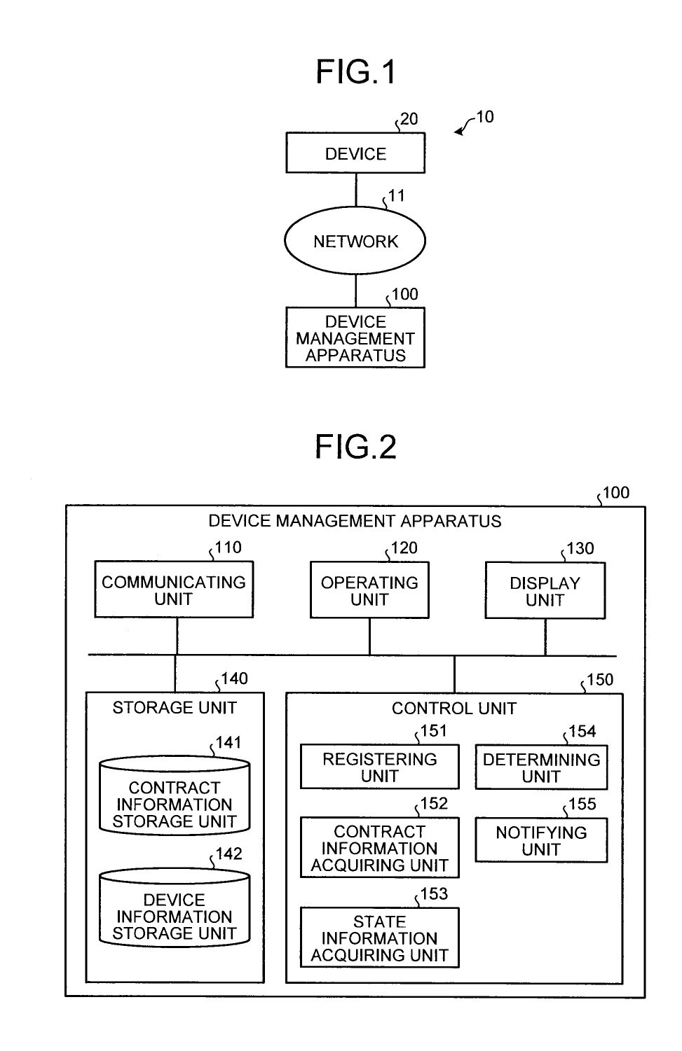

FIG. 1 is a block diagram illustrating a configuration example of a device management system 10 according to the first embodiment. As illustrated in FIG. 1, the device management system 10 includes a device 20 and a device management apparatus 100. The device 20 and the device management apparatus 100 are connected to each other via a network 11. The network 11 is realized by, for example, a LAN (Local Area Network) or the Internet.

In the first embodiment, the device 20 and the device management apparatus 100 are installed in a service site of a service provider that provides a device management service. The service site corresponds to, for example, an office of a company that receives the device management service. However, the installation location of the device management apparatus 100 is not limited to the service site. The device management apparatus 100 may be installed in a service center or the like.

The device management apparatus 100 manages the device 20, and is realized by a PC (Personal Computer) in which a device management program is installed. The device 20 may be any device as long as the device is connectable to the network 11. Examples of the device 20 include an image forming apparatus, such as a printer, a copier, a multifunction peripheral (MFP), a scanner, or a facsimile machine, various electronic devices, such as a projector, a camera, an air conditioner, a refrigerator, a fluorescent light, an automatic vending machine, or a handheld terminal, and an information processing apparatus, such as a PC. The MFP is a device having at least two of a copying function, a printing function, a scanning function, and a facsimile function.

In FIG. 1, an example is illustrated in which the device 20 that is an MFP is employed as a device to be managed by the device management apparatus 100. However, the device to be managed by the device management apparatus 100 is not limited to this example.

FIG. 2 is a block diagram illustrating a configuration example of the device management apparatus 100 according to the first embodiment. As illustrated in FIG. 2, the device management apparatus 100 includes a communicating unit 110, an operating unit 120, a display unit 130, a storage unit 140, and a control unit 150.

The communicating unit 110 performs communication with the device 20 via the network 11, and is realized by a communication device, such as a NIC (Network Interface Card).

The operating unit 120 inputs and outputs various operations, and is realized by at least one of input devices such as a keyboard, a mouse, a touch pad, and a touch panel.

The display unit 130 displays various screens, and is realized by a display device, such as a liquid crystal display or a touch panel display.

The storage unit 140 stores therein various programs, such as the device management program executed by the device management apparatus 100, data used in various processes performed by the device management apparatus 100, or the like. The storage unit 140 is realized by, for example, at least one of magnetic, optical, and electrical storage devices such as an HDD (Hard Disk Drive), an SSD (Solid State Drive), a memory card, an optical disk, a ROM (Read Only Memory), and a RAM (Random Access Memory).

The storage unit 140 includes a contract information storage unit 141 and a device information storage unit 142.

The contract information storage unit 141 stores therein contract information on quality assurance of a device to be managed by the device management apparatus 100. In the first embodiment, the contract information storage unit 141 stores therein a plurality of pieces of SLA information indicating contents of an SLA (Service Level Agreement) contract in a file format.

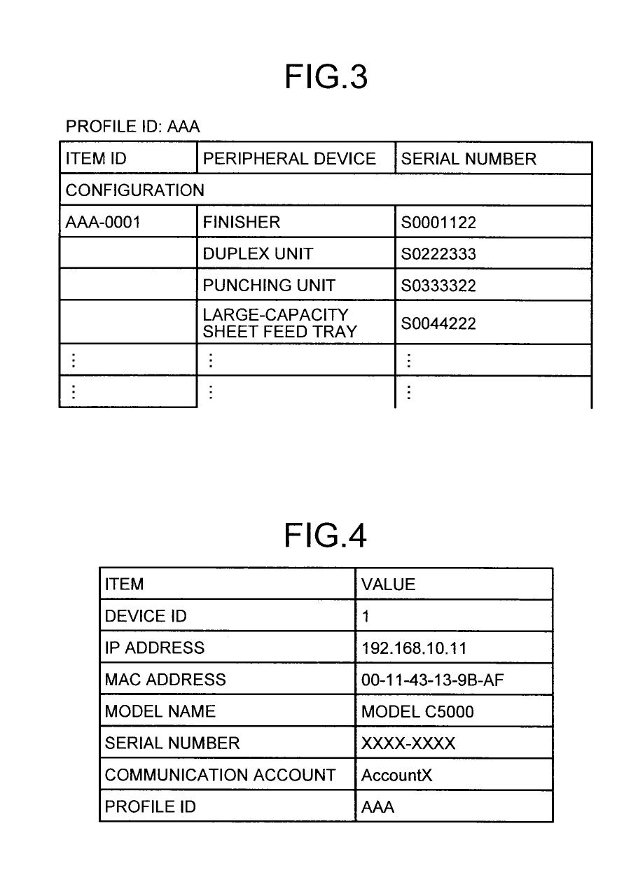

FIG. 3 is a diagram illustrating an example of the SLA information according to the first embodiment, in particular, the SLA information for a profile ID “AAA”. In the example illustrated in FIG. 3, the SLA information indicates, for each of items, peripheral devices (hereinafter, described as necessary peripheral devices) that need to be connected in a configuration corresponding to each of the items, and serial numbers of the necessary peripheral devices. For example, in the configuration for an item ID “AAA-0001”, if a finisher with a serial number “S0001122”, a duplex unit with a serial number “S0222333”, a punching unit with a serial number “S0333322”, or a large-capacity sheet feed tray with a serial number “S0044222” is not connected, there is an SLA violation.

The device information storage unit 142 stores therein device information of a device to be managed by the device management apparatus 100. In the first embodiment, the device information storage unit 142 stores therein the device information in a file format for each of devices to be managed.

FIG. 4 is a diagram illustrating an example of the device information according to the first embodiment, in particular, the device information of the device 20. In the example illustrated in FIG. 4, the device information contains device identification information, such as a device ID, an IP (Internet Protocol) address, a MAC (Media Access Control) address, a model name, a serial number, and a communication account, in association with a profile ID of the SLA information applied to the device (the device 20) indicated by the device identification information. In this example, the profile ID is “AAA” and the SLA information illustrated in FIG. 3 is applied to the device 20.

The control unit 150 controls each of the units of the device management apparatus 100, and is realized by a control device, such as a CPU (Central Processing Unit). The control unit 150 includes a registering unit 151, a contract information acquiring unit 152, a state information acquiring unit 153, a determining unit 154, and a notifying unit 155. The control unit 150 activates (executes) the device management program stored in the storage unit 140, to thereby realize the registering unit 151, the contract information acquiring unit 152, the state information acquiring unit 153, the determining unit 154, and the notifying unit 155 as software.

The registering unit 151 registers contract information on the device to be managed by the device management apparatus 100 in the contract information storage unit 141. For example, the registering unit 151 registers the SLA information illustrated in FIG. 3 in the contract information storage unit 141. The registering unit 151 may register, in the contract information storage unit 141, SLA information input by a user using the operating unit 120. It may be possible to provide an SLA information database (an example of a contract information storage device) (not illustrated) for storing the SLA information outside the device management apparatus 100, and cause the registering unit 151 to acquire the SLA information from the SLA information database via the network 11 and register the SLA information in the contract information storage unit 141. Namely, it may be possible to synchronize the SLA information between the SLA information database and the contract information storage unit 141.

The contract information acquiring unit 152 acquires contract information on quality assurance of the device 20. Specifically, the contract information acquiring unit 152 acquires the device information of the device 20 from the device information storage unit 142, and acquires the SLA information indicated by a profile ID set in the acquired device information from the contract information storage unit 141. In the first embodiment, the contract information acquiring unit 152 acquires the device information illustrated in FIG. 4 from the device information storage unit 142, and acquires the SLA information illustrated in FIG. 3 from the contract information storage unit 141 because the profile ID “AAA” is set in the acquired device information.

The state information acquiring unit 153 acquires state information indicating a state of the device 20 from the device 20. The state information acquiring unit 153 periodically acquires the state information of the device 20. The state information corresponds to any information on the device, such as configuration information, status information, and setting value information of the device. The configuration information is information indicating a configuration of the device, such as information on a peripheral device connected to the device. For example, the configuration information indicates a sheet feed tray, a finisher, a punching unit, or a duplex unit. The status information is information indicating a status of the device, for example, indicating whether the device is in a specific state. For example, the status information indicates error, no toner, or no sheet. The setting value information is information indicating settings of the device. For example, the setting value information indicates network information, a sheet setting, user information, or a print history.

In the first embodiment, the state information acquiring unit 153 communicates with the device 20 by using a protocol, such as an SNMP (Simple Network Management Protocol) every time a predetermined time is measured by a timer (not illustrated) of the device management apparatus 100, and acquires the state information.

However, the method for acquiring the state information is not limited to the above method, in which the state information acquiring unit 153 sends a request for acquisition of the state information to the device 20 and acquires the state information from the device 20. For example, a method may be employed, in which the device 20 actively notifies the device management apparatus 100 (the state information acquiring unit 153) of the state information.

The determining unit 154 determines whether the state of the device 20 satisfies a content of a contract based on the contract information acquired by the contract information acquiring unit 152 and the state information acquired by the state information acquiring unit 153. In the first embodiment, the determining unit 154 determines whether the state of the device 20 satisfies the content of the contract based on the state information and the contract information every time the state information acquiring unit 153 acquires the state information.

Specifically, the determining unit 154 refers to the configuration information contained in the state information acquired by the state information acquiring unit 153, and determines whether a necessary peripheral device, which needs to be connected to the device 20 according to the SLA information (see FIG. 3) acquired by the contract information acquiring unit 152, is connected to the device 20.

In this case, if the configuration information indicates a finisher with a serial number “S0001122”, a duplex unit with a serial number “S0222333”, a punching unit with a serial number “S0333322”, and a large-capacity sheet feed tray with a serial number “S0044222”, the determining unit 154 determines that there is no SLA violation. On the other hand, if the configuration information does not indicate at least one of the finisher with the serial number “S0001122”, the duplex unit with the serial number “S0222333”, the punching unit with the serial number “S0333322”, and the large-capacity sheet feed tray with the serial number “S0044222”, the determining unit 154 determines that there is an SLA violation.

The notifying unit 155 notifies a determination result of the determining unit 154. Specifically, when the determination result of the determining unit 154 indicates a contract violation, the notifying unit 155 notifies the determination result indicating the contract violation. For example, when the determination result of the determining unit 154 indicates an item ID “AAA-0001” as an item causing an SLA violation, the notifying unit 155 notifies the devices ID “1” assigned to the device 20 and the item ID “AAA-0001”. For example, the notifying unit 155 notifies an administrator (a PC of the administrator) of the device management apparatus 100 of the determination result by an electronic mail (e-mail) or the like.

The device management apparatus 100 does not necessarily have to include all of the units described above, and a part of the units may be omitted.

Operations of the device management system according to the first embodiment will be explained below.

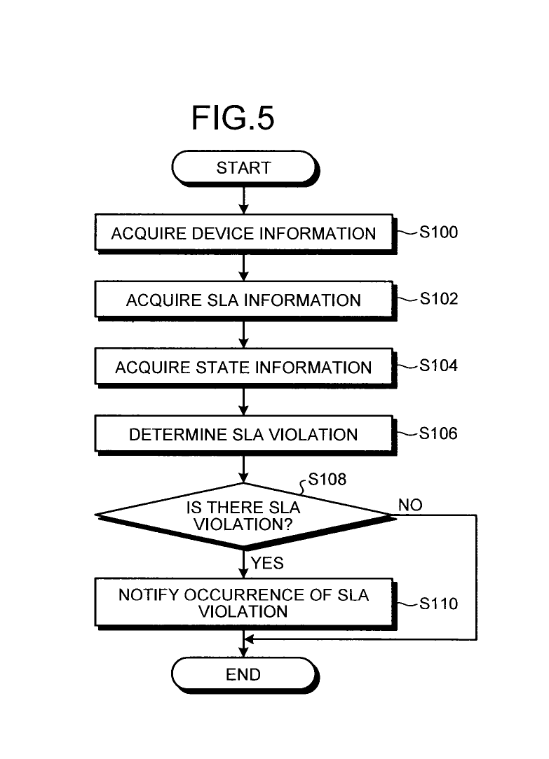

FIG. 5 is a flowchart illustrating an exemplary process performed by the device management apparatus 100 according to the first embodiment.

The contract information acquiring unit 152 acquires the device information of the device 20 from the device information storage unit 142 (Step S100).

The contract information acquiring unit 152 acquires the SLA information indicated by a profile ID set in the acquired device information from the contract information storage unit 141 (Step S102).

The state information acquiring unit 153 acquires the state information of the device 20 from the device 20 at an acquisition timing of the state information (Step S104).

The determining unit 154 determines whether there is an SLA violation in the state of the device 20 based on the contract information acquired by the contract information acquiring unit 152 and the state information acquired by the state information acquiring unit 153 (Step S106).

When the determination result of the determining unit 154 indicates that there is the SLA violation (YES at Step S108), the notifying unit 155 notifies an occurrence of the SLA violation (Step S110). On the other hand, when the determination result of the determining unit 154 indicates that there is no SLA violation (NO at Step S108), the notifying unit 155 does not issue any notice and the process ends.

As described above, according to the first embodiment, when an SLA violation has occurred, the SLA violation is notified. Therefore, it is possible to resolve the SLA violation, enabling to prevent reduction in the service level.

### Second Embodiment

In a second embodiment, an example will be explained in which not only a notice indicating an occurrence of an SLA violation but also improvement information are notified to prevent the SLA violation from getting worse. In the following, differences from the first embodiment will be mainly explained. Components having the same functions as those of the first embodiment are denoted by the same names and reference numerals as those of the first embodiment, and explanation thereof will be omitted.

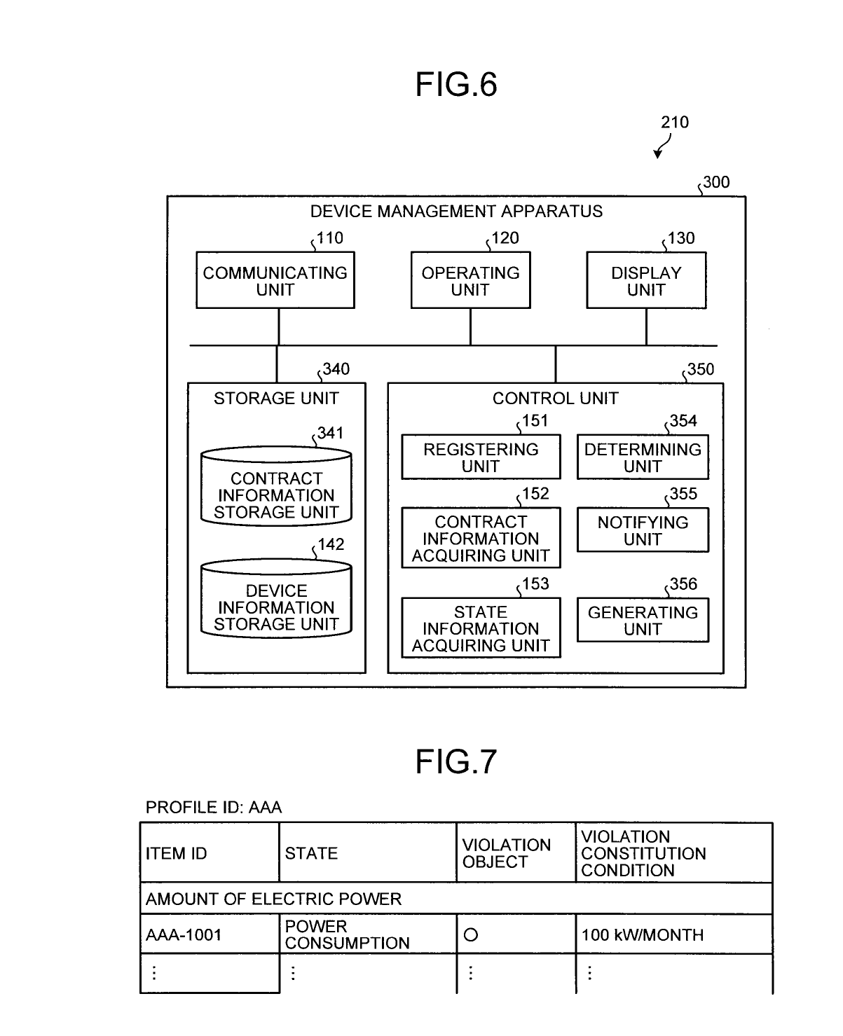

FIG. 6 is a block diagram illustrating a configuration example of a device management apparatus 300 of a device management system 210 according to the second embodiment. As illustrated in FIG. 6, in the second embodiment, a contract information storage unit 341 of a storage unit 340, and a determining unit 354, a notifying unit 355, and a generating unit 356 of a control unit 350 are different from the first embodiment.

The contract information storage unit 341 stores therein SLA information indicating an upper limit value of the amount of consumption of a predetermined object during a second period. In the second embodiment, an example will be explained in which electric power is employed as the predetermined object. However, the present invention is not limited to this example. For example, the predetermined object may be an environment-related object, such as electric power or carbon dioxide (CO₂), may be toner, or may be the number of sheets.

FIG. 7 is a diagram illustrating an example of the SLA information according to the second embodiment, in particular, the SLA information for a profile ID “AAA”. In the example illustrated in FIG. 7, the SLA information indicates that the upper limit of power consumption is 100 kW per month. Therefore, if the power consumption in one month (from the beginning to the end of a month) exceeds 100 kW, there is an SLA violation.

The contract information acquiring unit 152 acquires the device information illustrated in FIG. 4 from the device information storage unit 142, and acquires the SLA information illustrated in FIG. 7 from the contract information storage unit 341 because the profile ID “AAA” is set in the acquired device information.

The state information acquiring unit 153 periodically (for example, for each day) acquires the state information indicating the state of the device 20 from the device 20. In the second embodiment, the state information indicates at least the amount of consumption of a predetermined object of the device during a first period. For example, the state information indicates the power consumption per day. However, as described above, the predetermined object may be an environment-related object, such as electric power or carbon dioxide, may be toner, or may be the number of sheets. For example, the device 20 manages, as an ecology log, the amount of electric power or carbon dioxide that the device 20 consumes per day; therefore, the value of the amount of consumption may be used. Furthermore, the state information may contain various settings, such as a time to transit to a power saving mode of the device 20 (hereinafter, this mode may be described as “a sleep mode”). Note that the first period is shorter than the second period.

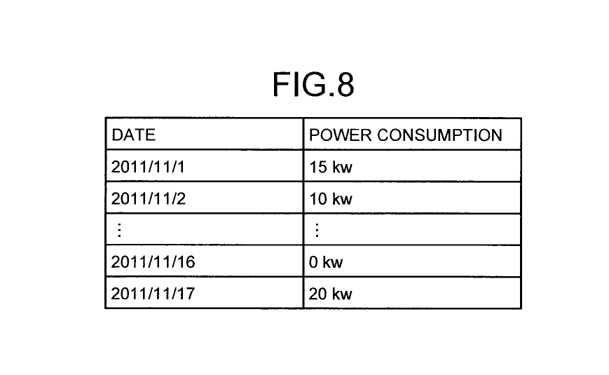

The state information acquiring unit 153 stores at least the power consumption contained in the acquired state information in the storage unit 340, in association with a current date. Therefore, as illustrated in FIG. 8 for example, the power consumption of the device 20 per day is accumulated in the storage unit 340.

The determining unit 354 determines whether a total amount of consumption of the predetermined object of the device 20 during the second period exceeds the upper limit. Specifically, the determining unit 354 determines whether the total amount of consumption, which is the sum total of the power consumptions in a current month (from the beginning to the end of the month) from among the power consumptions of the device 20 acquired by the state information acquiring unit 153 and accumulated in the storage unit 340, has exceeded the upper limit defined in the SLA information (see FIG. 7) acquired by the contract information acquiring unit 152.

In this case, if the total amount of consumption has not exceeded 100 kW, the determining unit 354 determines that there is no SLA violation. If the total amount of consumption has exceeded 100 kW, the determining unit 354 determines that there is an SLA violation.

When the determination result of the determining unit 354 indicates that there is the SLA violation, the generating unit 356 generates improvement information for preventing the SLA violation from getting worse. Specifically, the generating unit 356 generates, as the improvement information, information to urge a change to a setting so as to reduce the amount of consumption of the predetermined object. For example, the generating unit 356 generates the improvement information to urge a change to a setting so that the transition time to the sleep mode of the device 20 can be reduced. When the state information acquired by the state information acquiring unit 153 contains a current transition time to the sleep mode of the device 20, it may be possible to generate information to urge a change to a transition time shorter than the current transition time.

When the determination result of the determining unit 354 indicates that there is the SLA violation, the notifying unit 355 notifies the determination result and the improvement information generated by the generating unit 356. For example, when the determination result of the determining unit 354 indicates an item ID “AAA-1001” as an item causing the SLA violation, the notifying unit 355 notifies the device ID “1” assigned to the device 20, the item ID “AAA-1001”, and the improvement information. For example, the notifying unit 355 notifies an administrator (a PC of the administrator) of the device management apparatus 300 of the determination result and the improvement information by an electronic mail (e-mail) or the like.

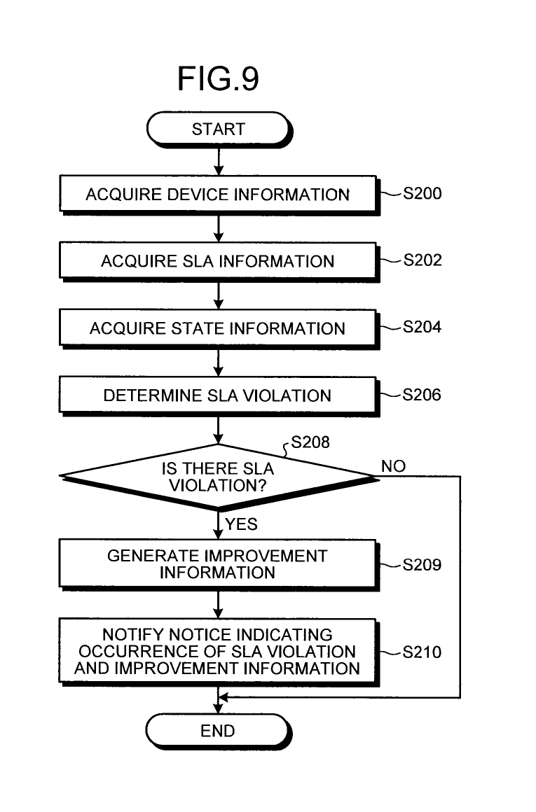

FIG. 9 is a flowchart illustrating an exemplary process performed by the device management apparatus 300 according to the second embodiment.

The contract information acquiring unit 152 acquires the device information of the device 20 from the device information storage unit 142 (Step S200).

The contract information acquiring unit 152 acquires the SLA information (see FIG. 7) indicated by the profile ID set in the acquired device information from the contract information storage unit 341 (Step S202).

The state information acquiring unit 153 acquires the state information of the device 20 from the device 20 at an acquisition timing of the state information and stores, in the storage unit 340, at least the power consumption contained in the state information (Step S204).

The determining unit 354 determines whether the total amount of consumption, which is the sum total of the power consumptions in a current month (from the beginning to the end of the month) from among the power consumptions of the device 20 accumulated in the storage unit 340, has exceeded the upper limit defined in the SLA information acquired by the contract information acquiring unit 152 (Step S206).

When the determination result of the determining unit 354 indicates that there is the SLA violation (YES at Step S208), the generating unit 356 generates improvement information to urge, for example, a change to a setting so that the transition time to the sleep mode of the device 20 can be reduced (Step S209), and the notifying unit 355 notifies the improvement information together with the notice indicating an occurrence of the SLA violation (Step S210). On the other hand, when the determination result of the determining unit 354 indicates that there is no SLA violation (NO at Step S208), the notifying unit 355 does not issue any notice and the process ends.

According to the second embodiment as described above, because the amount of consumption of a predetermined object during a predetermined period is employed as the SLA information, even if a notice indicating an occurrence of the SLA violation is issued, it may be impossible to resolve the SLA violation. However, if the SLA violation is left unresolved, a severe SLA violation may occur. Therefore, in the second embodiment, when the SLA violation has occurred, the improvement information for preventing the SLA violation from getting worse is notified in addition to the notice indicating an occurrence of the SLA violation. Therefore, it becomes possible to prevent the SLA violation from getting worse, enabling to prevent reduction in the service level.

### Third Embodiment

In a third embodiment, another example will be explained in which not only a notice indicating an occurrence of an SLA violation but also the improvement information are notified to prevent the SLA violation from getting worse. In the following, differences from the second embodiment will be mainly explained. Components having the same functions as those of the second embodiment are denoted by the same names and reference numerals as those of the second embodiment, and explanation thereof will be omitted.

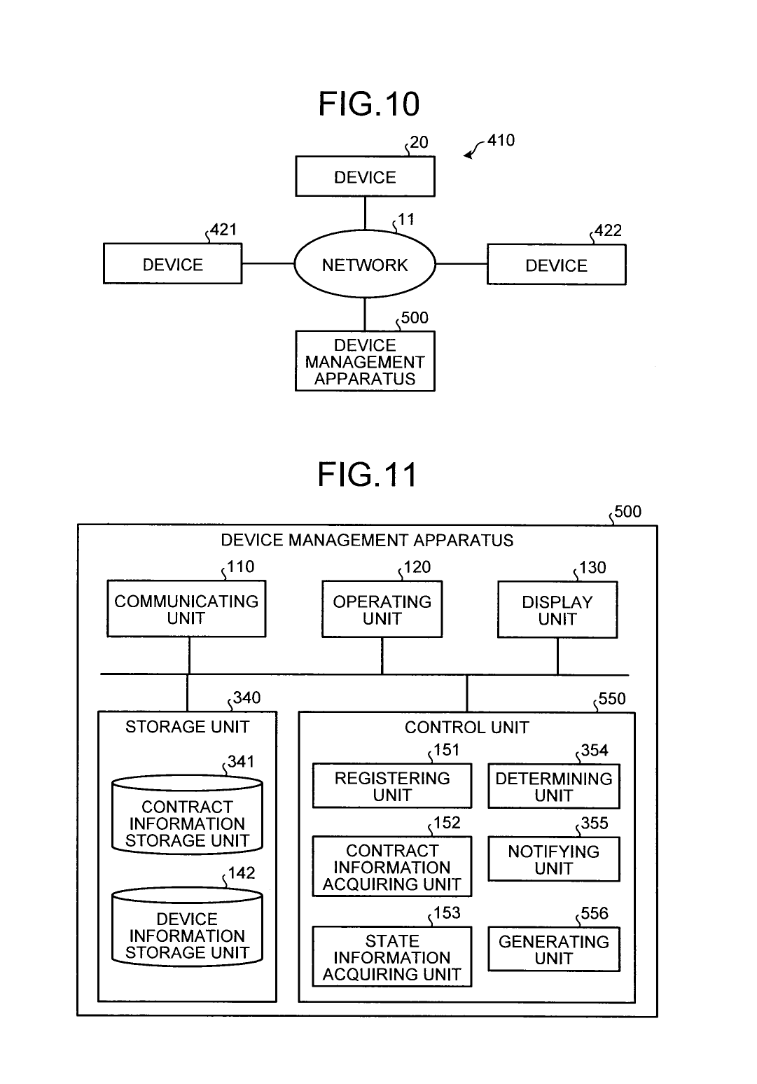

FIG. 10 is a block diagram illustrating a configuration example of a device management system 410 according to the third embodiment. As illustrated in FIG. 10, the device management system 410 includes devices 421 and 422 as the devices to be managed by a device management apparatus 500, in addition to the device 20. The devices 421 and 422 are connected to the device management apparatus 500 via the network 11.

FIG. 11 is a block diagram illustrating a configuration example of the device management apparatus 500 according to the third embodiment. As illustrated in FIG. 11, in the third embodiment, a generating unit 556 of a control unit 550 is different from the second embodiment.

The contract information acquiring unit 152 acquires the device information from the device information storage unit 142 for each of the devices to be managed, and acquires the SLA information indicated by a profile ID contained in the acquired device information from the contract information storage unit 341. In the third embodiment, it is assumed that the SLA information illustrated in FIG. 7 is applied to all of the devices 20, 421, and 422.

The state information acquiring unit 153 periodically (for example, for each day) acquires the state information from each of the devices to be managed.

The determining unit 354 determines whether the total amount of consumption of a predetermined object of each of the devices during the second period has exceeded the upper limit for each of the devices to be managed.

When the determination result of the determining unit 354 indicates that there is an SLA violation, the generating unit 556 generates, as the improvement information, information to urge use of a device whose total amount of consumption has not exceeded the upper limit from among the devices to be managed. For example, assuming that the total amount of consumption of the device 20 has not exceeded the upper limit but the total amount of consumption of each of the devices 421 and 422 has exceeded the upper limit among the devices 20, 421, and 422, the generating unit 556 generates information to urge use of the device 20 among the devices 20, 421, and 422.

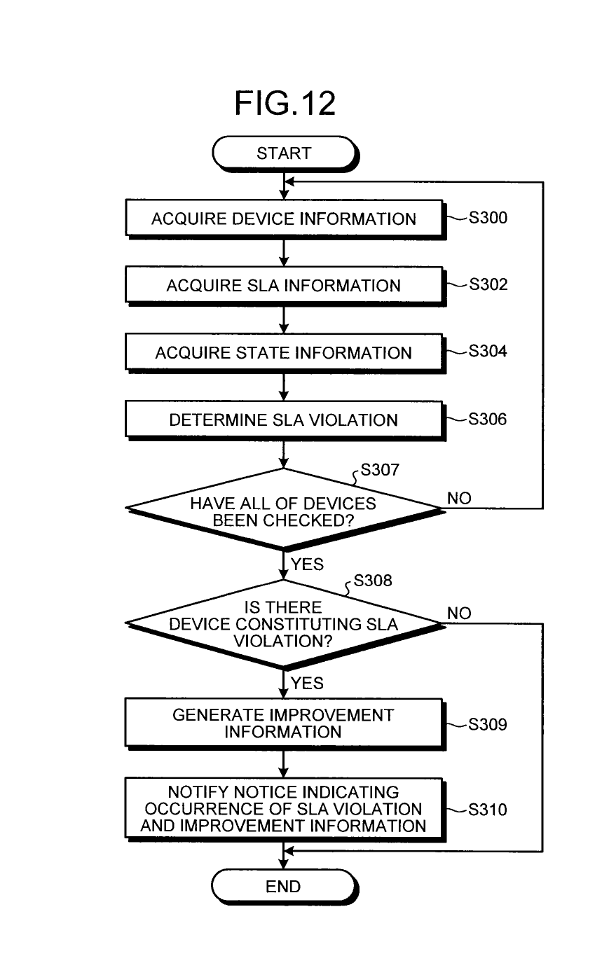

FIG. 12 is a flowchart illustrating an exemplary process performed by the device management apparatus 500 according to the third embodiment.

The processes from Steps S300 to S306 are the same as the processes from Steps S200 to S206 illustrated in FIG. 9.

The device management apparatus 500 repeats the processes from Steps S300 to S306 until completing checking of the SLA violation for all of the devices to be managed (NO at Step S307).

When the device management apparatus 500 has completed checking of the SLA violation for all of the devices to be managed (YES at Step S307), and if there is a device whose determination result of the determining unit 354 indicates an occurrence of the SLA violation (YES at Step S308), the generating unit 556 generates the improvement information to urge use of a device whose total amount of consumption has not exceeded the upper limit (Step S309), and the notifying unit 355 notifies a notice indicating an occurrence of the SLA violation and the improvement information (Step S310). On the other hand, when there is no device whose determination result of the determining unit 354 indicates an occurrence of the SLA violation (NO at Step S308), the notifying unit 355 does not issue any notice and the process ends.

As described above, in the third embodiment, when the SLA violation has occurred, not only a notice indicating an occurrence of the SLA violation but also the improvement information for preventing the SLA violation from getting worse are notified. Therefore, it is possible to prevent the SLA violation from getting worse, enabling to prevent a reduction in the service level.

Modifications

The present invention is not limited to the above embodiments, but may be modified in various forms.

First Modification

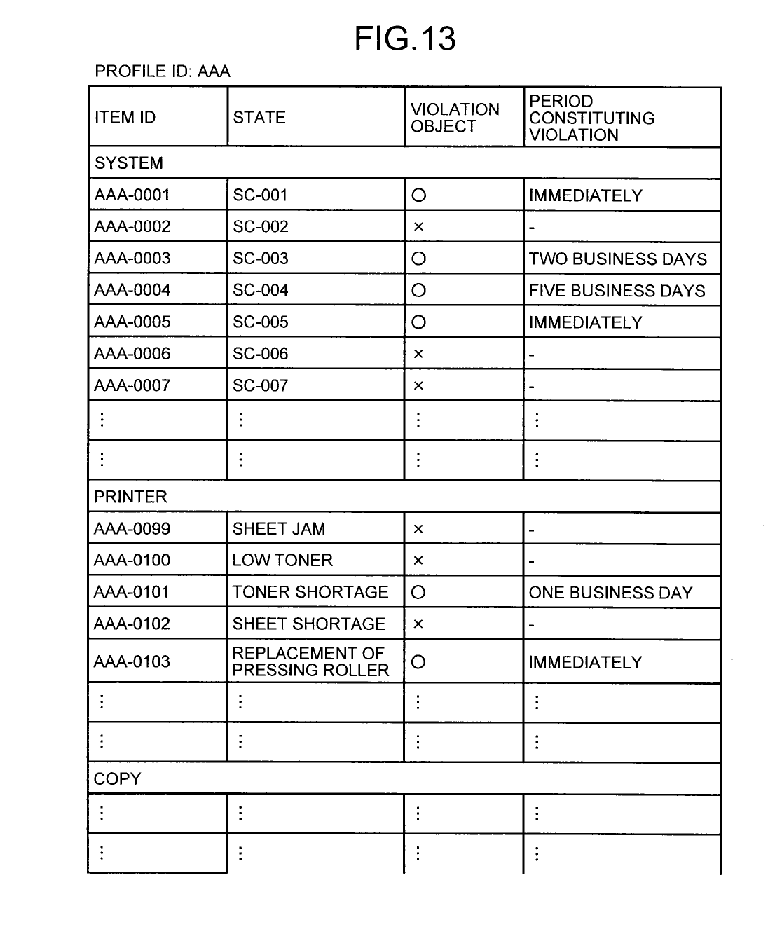

In the first embodiment described above, an example has been explained in which the SLA information on the configuration of a device as illustrated FIG. 3 is employed; however, the SLA information is not limited to this example. For example, SLA information on the status of a device as illustrated in FIG. 13 may be employed.

FIG. 13 is a diagram illustrating an example of SLA information according to a modification, in particular, SLA information for a profile ID “AAA”. In the example illustrated in FIG. 13, the SLA information indicates whether the state of each of items is an object of the SLA violation (hereinafter, the state of an item to be an object of the SLA violation may be described as a specific state), and a period that constitutes the SLA violation for the state of the item being the object of the SLA violation. For example, it is indicated that sheet jam with an item ID “AAA-0099” does not constitute the SLA violation, toner shortage with an item ID “AAA-0101” constitutes the SLA violation if it continues for one business day from an occurrence of the toner shortage (over one business day), and replacement of a pressing roller with an item ID “AAA-0103” constitutes the SLA violation immediately after the replacement occurs. Namely, the SLA information indicates a predetermined period permitted to resolve a specific state.

In this case, the determining unit 154 determines whether the state indicated by the status information acquired by the state information acquiring unit 153 is an object of the SLA violation by referring to the SLA information (see FIG. 13) acquired by the contract information acquiring unit 152. If the state indicted by the status information is the object of the SLA violation, the determining unit 154 determines whether the state (special state) has continued for a period that constitutes the SLA violation.

If the period that constitutes the SLA violation indicates an immediate time, because the state has already continued for the period that constitutes the SLA violation, the determining unit 154 determines that the item in the state constitutes the SLA violation. Specifically, when the SLA information defines that a state of an item constitutes the SLA violation upon occurrence of the state, and if the state information acquiring unit 153 acquires the state information indicating the state (special state) of the item, the determining unit 154 determines, as a determination result, that the SLA violation has occurred with respect to the item.

Furthermore, if the period that constitutes the SLA violation indicates other than an immediate time, the determining unit 154 measures, on the storage unit 140, the number of times that the state information acquiring unit 153 continues to acquire the state information indicating the state of the item. The determining unit 154 calculates the duration of the state of the item based on the number of continuous acquisitions and based on intervals of the acquisitions of the state information by the state information acquiring unit 153. When the calculated duration reaches the period that constitutes the SLA violation, the determining unit 154 determines that the SLA violation has occurred with respect to the item. The determining unit 154 restores the number of continuous acquisitions to the initial value when the state information acquiring unit 153 acquires the state information that does not indicate the state of the item.

Specifically, when the SLA information defines that a state of an item constitutes the SLA violation upon continuation of the state for a predetermined period, and if the state information acquiring unit 153 continues to acquire the state information indicating the state (specific state) of the item and a duration of the state of the item reaches a predetermined period, the determining unit 154 determines, as a determination result, that the SLA violation has occurred with respect to the item.

The SLA information may be SLA information on settings of a device. In this case, the SLA information indicates a setting needed for each of items (hereinafter, described as a necessary setting). The determining unit 154 determines whether the setting of the device 20 corresponds to the necessary setting of the SLA information acquired by the contract information acquiring unit 152 by referring to the setting information contained in the state information acquired by the state information acquiring unit 153.

Second Modification

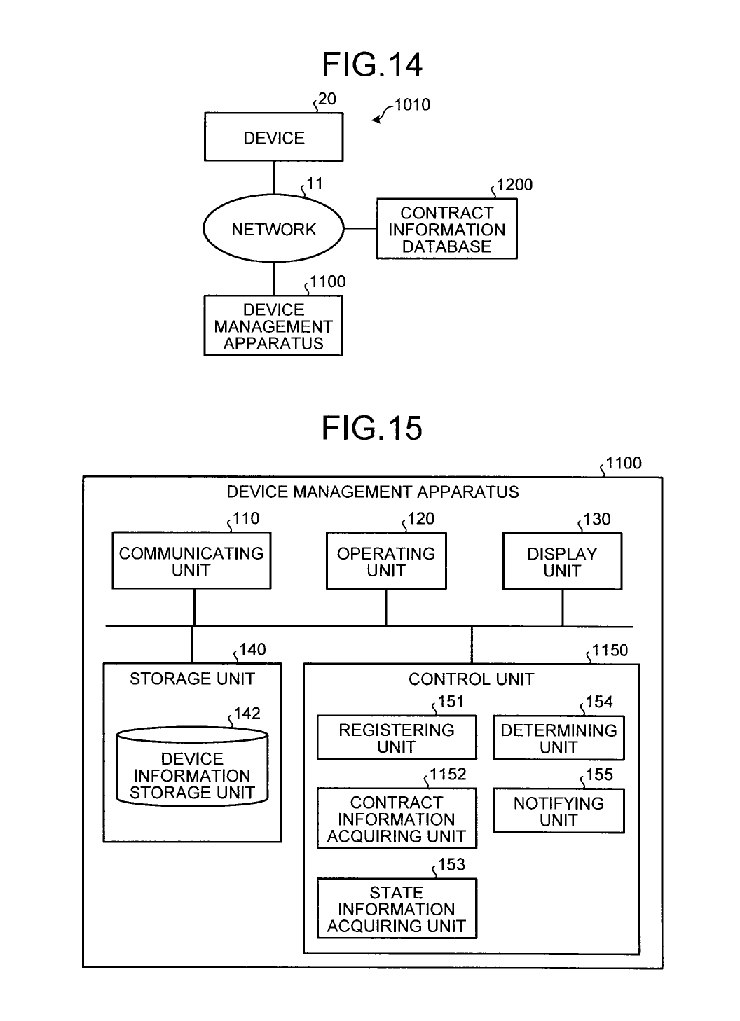

In the embodiments described above, an example has been explained in which the device management apparatus stores therein the SLA information. However, the SLA information may be stored in an external apparatus. For example, as in a device management system 1010 illustrated in FIG. 14 and FIG. 15, it may be possible to provide a contract information database 1200 (an example of a contract information storage device) for storing the SLA information outside a device management apparatus 1100 (for example, on the cloud), and cause a contract information acquiring unit 1152 of a control unit 1150 to acquire the SLA information from the contract information database 1200 via the network 11.

Third Modification

Alternatively, for example, it may be possible to notify a method to resolve the SLA violation as the improvement information for resolving the SLA violation, in addition to a notice indicating an occurrence of the SLA violation to resolve the SLA violation in the first embodiment or the modifications described above. In this case, it is sufficient to provide a generating unit for generating the improvement information in the device management apparatus, even in the first embodiment or the modifications described above.

Hardware Configuration

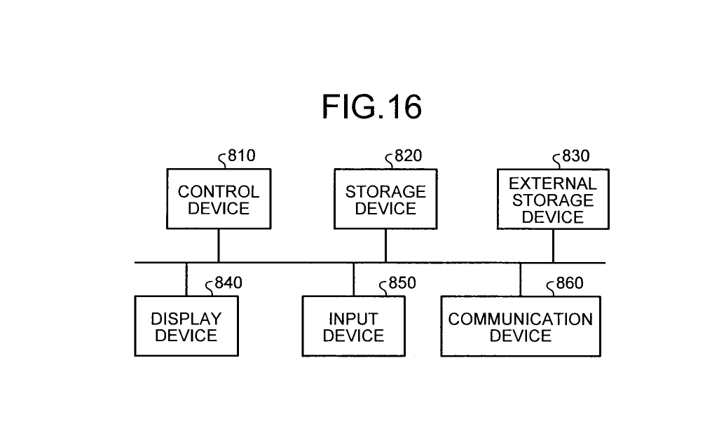

FIG. 16 is a block diagram illustrating an example of a hardware configuration of the device management apparatus according to the embodiments and the modifications described above. The device management apparatus according to the embodiments and the modifications includes a control device 810, such as a CPU, a storage device 820, such as a ROM or a RAM, an external storage device 830, such as an HDD, a display device 840, such as a display, an input device 850, such as a keyboard or a mouse, and a communication device 860, such as a communication interface, and has a hardware configuration using a normal computer.

The device management program executed by the device management apparatus according to the embodiments and the modifications is provided by being stored in a computer-readable recording medium, such as a CD-ROM, a CD-R, a memory card, a DVD (Digital Versatile Disk), or a flexible disk (FD), in a computer-installable or a computer-executable file format.

The device management program executed by the device management apparatus according to the embodiments and the modifications may be stored in a computer connected to a network, such as the Internet, and be provided by downloading via the network. The device management program executed by the device management apparatus according to the embodiments and the modifications may be provided or distributed via a network, such as the Internet. The device management program executed by the device management apparatus according to the embodiments and the modifications may be provided by being stored in a ROM or the like in advance.

The device management program executed by the device management apparatus according to the embodiments and the modifications has a module structure for realizing the above-described units on a computer. As actual hardware, the CPU loads the program from the HDD onto the RAM and executes the program to thereby realize the above units on the computer.

According to an embodiment of the present invention, it is possible to prevent a reduction in a service level.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management apparatus that manages a device, the device management apparatus comprising:
a contract information acquiring unit that acquires contract information on quality assurance of the device;
a state information acquiring unit that acquires state information indicating a state of the device;
a determining unit that determines whether the state of the device satisfies a content of a contract based on the contract information and the state information; and
a notifying unit that notifies a determination result.

2. The device management apparatus according to claim 1, wherein
the state information indicates a peripheral device connected to the device,
the contract information indicates a necessary peripheral device that needs to be connected to the device, and
the determining unit determines whether the necessary peripheral device is connected to the device.

3. The device management apparatus according to claim 1, wherein
the state information indicates whether the device is in a specific state,
the contract information indicates a predetermined period permitted to resolve the specific state, the state information acquiring unit periodically acquires the state information, and
the determining unit determines whether the specific state has continued for the predetermined period.

4. The device management apparatus according to claim 1, wherein
the state information indicates a setting of the device,
the contract information indicates a necessary setting that needs to be set, and
the determining unit determines whether the setting is the necessary setting.

5. The device management apparatus according to claim 1, wherein the notifying unit notifies the determination result when the determination result indicates a violation of the contract.

6. The device management apparatus according to claim 1, further comprising:
a generating unit that generates improvement information for preventing a violation of the contract from getting worse when the determination result indicates the violation of the contract, wherein
the notifying unit notifies the determination result and the improvement information when the determination result indicates the violation of the contract.

7. The device management apparatus according to claim 6, wherein
the state information indicates an amount of consumption of a predetermined object of the device in a first period,
the contract information indicates an upper limit value of the amount of consumption of the predetermined object in a second period that is longer than the first period,
the state information acquiring unit periodically acquires the state information,
the determining unit determines whether a total amount of consumption of the predetermined object of the device in the second period has exceeded the upper limit value, and
the generating unit generates, as the improvement information, information to urge a change to a setting so as to reduce the amount of consumption of the predetermined object.

8. The device management apparatus according to claim 6, wherein
a plurality of the devices are provided,
the contract information acquiring unit acquires the contract information from each of the devices,
the state information acquiring unit periodically acquires the state information from each of the devices,
the determining unit determines, for each of the devices, whether a total amount of consumption of the predetermined object of the device in the second period has exceeded the upper limit value, and
the generating unit generates, as the improvement information, information to urge use of a device whose total amount of consumption has not exceeded the upper limit value from among the devices.

9. The device management apparatus according to claim 1, further comprising:
a contract information storage unit that stores therein the contract information, wherein
the contract information acquiring unit acquires the contract information from the contract information storage unit.

10. The device management apparatus according to claim 1, further comprising a registering unit that registers the contract information in the contract information storage unit.

11. The device management apparatus according to claim 10, wherein the registering unit acquires the contract information from a contract information storage device that stores therein the contract information, and registers the contract information in the contract information storage unit.

12. A device management system that manages a device, the device management system comprising:
a contract information storage unit that stores therein contract information on quality assurance of the device;
a contract information acquiring unit that acquires the contract information from the contract information storage unit;
a state information acquiring unit that acquires state information indicating a state of the device;
a determining unit that determines whether the state of the device satisfies a content of a contract based on the contract information and the state information; and
a notifying unit that notifies a determination result.

13. A device management system that manages a device, the device management system comprising:
a device management apparatus that manages the device;
a contract information storage device that stores therein contract information on quality assurance of the device;
a contract information acquiring unit that acquires the contract information from the contract information storage device;
a state information acquiring unit that acquires state information indicating a state of the device;
a determining unit that determines whether the state of the device satisfies a content of a contract based on the contract information and the state information; and
a notifying unit that notifies a determination result.
